(19) United States
(12) Patent Application Publication
(10) Pub. No.: US 2011/0124384 A1
(43) Pub. Date: May 26, 2011

(54) FOLDABLE PORTABLE TERMINAL DEVICE

(75) Inventors: Yasutoki Manda, Kanagawa (JP); Hidehiro Yanagibashi, Kanagawa (JP); Haruo Hayakawa, Kanagawa (JP)

(73) Assignee: PANASONIC CORPORATION, Osaka (JP)

(21) Appl. No.: 12/995,986

(22) PCT Filed: Feb. 10, 2009
(86) PCT No.: PCT/JP2009/000543

§ 371 Date: Jan. 18, 2011

(30) Foreign Application Priority Data
Jun. 3, 2008 (JP) 2008-145314

(51) Int. Cl. H04W 88/02

(52) U.S. Cl. 455/575.3

(57) ABSTRACT

Orientation of display of an operation portion can be changed according to a screen of a display portion in a portable terminal apparatus capable of opening and closing a second casing with respect to a first casing in a first direction and a second direction.

A portable terminal apparatus includes a first casing 1 including an operation portion and a second casing 2 including a display portion which are connected through a connection portion 3. The connection portion 3 includes a first rotation shaft 9 capable of rotating the second casing 2 in a first direction and a second rotation shaft 10 capable of rotating the second casing 2 in a second direction perpendicular to the first direction. The first rotation shaft 9 includes a protrusion portion 12. The first casing 1 includes a key top sheet 16, a slide sheet 13, a frame portion 6 which surrounds the slide sheet, a cam follower member 7, a first elastic member 11 configured to urge the cam follower member 7 and a second elastic member 17 which connects the slide sheet 13 to the cam follower member 7. When the first rotation shaft 9 rotates, the protrusion portion 12 presses the cam follower member 7 and the second elastic member 17, whereby the slide sheet 13 moves.

### TECHNICAL FIELD

The present invention relates to a folding portable terminal apparatus in which two casings are connected so as to be opened and closed in a first direction and a second direction.

### BACKGROUND ART

As a usage of a foldable mobile telephone in which two casings are connected so as to overlap, a user generally holds a first casing including an operation portion such as a ten-key pad in user's hand and views a second casing including a display portion by setting the foldable mobile telephone in a state in which the foldable mobile telephone is opened around a connection portion.

Recently, a mobile telephone capable of receiving and displaying a television broadcast is put to practical use and starts to become widespread. In order to view a landscape television broadcast screen, it is known to be preferable to rotate a display portion in a second direction. In view of this, there is proposed a mechanism for switching a direction of the display portion from a first direction to the second direction by mechanically rotating the second casing including the display portion in the second direction around a rotation shaft provided in an end portion of the second casing (for example, see Patent Document 1).

FIGS. 18 and 19 show one example of the foldable mobile telephone proposed conventionally. A mobile telephone 60 of FIG. 18 includes three casings, i.e., a first casing 61 including an operation portion 71, a second casing 62 including a display portion 72, and a connection portion 63. The connection portion 63 is rotatably supported in a direction of arrow A by a first rotation shaft 61a provided in the first casing 61.

By rotating the connection portion 63 in the direction of arrow A, the second casing 62 can be opened in a first direction with respect to the first casing 61. A second rotation shaft 63a is provided in the connection portion 63 and rotatably supports the second casing 62. Consequently, the mobile telephone 60 can be used in a form of opening the display portion 72 of the second casing 62 in a second direction finally as shown in FIG. 19.

In this case, when the second casing 62 is opened in the second direction and the display portion 72 is set in a landscape state, it is convenient to change arrangement and orientation of the operation portion 71 such as a ten-key pad to arrangement and orientation for viewing a television broadcast.

As a method for that purpose, it may be considered that the operation portion is configured by a touch panel with a liquid crystal display and to change key arrangement and orientation of the liquid crystal display every time orientation of the display portion 72 changes. However, it may not be appropriate to maintain the liquid crystal display and backlight in ON state while the television broadcast is viewed.

Therefore, after the liquid crystal display is once turned off, the channel can be selected as necessary by touching the touch panel so as to again turn on the liquid crystal display. Further, it is considered to make no display in an optimum character input direction when open/close operation of the casing is performed in a power-off state (for example, see Patent Document 2).

In addition, as another known conventional example, in a key structure of an electronic device including a key top and a key function display portion for indicating a key function display of each key so as to be confirmed from the outside, a position of the key function display portion relative to the key top can be changed such that the key function display which can be confirmed from the outside switches according to a change in the relative position (for example, see Patent Document 3).

FIG. 20 shows a schematic front view of the conventional electronic device described above, and FIG. 21 shows a partial section of a key function display plate 84 and a key top 91 cut along a line C-C of FIG. 20. In FIG. 21, a keyboard 90 slides on a lower casing 81 right and left.

The right and left movement of the keyboard 90 is detected by a conduction between a conductor 93 provided in a right end of the keyboard 90 and two terminals 83 of the lower casing 81 when the conductor 93 slides. When the keyboard 90 is set in one portion, alphabetical input can be allowed, and when the keyboard 90 is set in the other portion, Japanese character input can be allowed.

As shown in FIG. 20, a key 91a of the keyboard 90 includes a transparent portion 91b in the center thereof. Further, as shown in FIG. 21, a lower surface of the key 91a slidably and surface-to surface contacts an upper surface 84a of the key function display plate 84.

The lower end of the key function display plate 84 is fixed to and perpendicular to the lower casing 81 of a body of an electronic device 80, and the key function display plate 84 is bent stepwise halfway such that the upper surface 84a on which a character is printed becomes horizontal. On the upper surface 84a, Japanese character display and alphabetical display are indicated and spaced at a certain width in right and left direction. The certain width is equal to a slide stroke of the keyboard 90.

Also, a size of the transparent portion 91b is slightly larger than a character display of the key function display plate 84 such that two characters can not be seen through the transparent portion 91b. When the keyboard 90 is moved to the right or the left in FIG. 20, the contents of display seen through the transparent portion 91b switch to the Japanese character display or the alphabetical display.

For the key structure described above, the contents of display of the key function display plate can, be switched even when a power supply of the body of the electronic device 80 is not turned on.
Patent Document 1: JP-A-2006-22899
Patent Document 2: JP-A-2001-296958
Patent Document 3: JP-A-2002-7034

### DISCLOSURE OF THE INVENTION

### Problem to be Solved by the Invention

A first problem of the invention is, in a foldable portable terminal apparatus, e.g., a mobile telephone, a game machine or PDA (Personal Digital Assistants) having a television receiving function, including a connection portion containing two rotation shafts so as to open and close the apparatus in a first direction and a second direction, to change characters printed on an operation portion such as a ten-key pad according to orientation of a display device of liquid crystal etc. when a second casing is opened from a folded state by rotating the rotation shaft of the connection portion.

A second problem is to provide a user-friendly portable terminal apparatus capable of switching the characters printed on the operation portion such as the ten-key pad according to the orientation of the display device of liquid crystal etc. even when a power source is not turned on.

A third problem is to allow a change in the characters according to the orientation of the display device by opening or closing the second casing with respect to a first casing even when a user does not intentionally perform an operation for the change.

A fourth problem is, in a configuration for changing the characters according to the orientation of the display device, to provide a portable terminal apparatus without breaking a drive mechanism even in the case of opening or closing the second casing in a state in which a key remains fixed by an external force, for example, the state in which the key is held by hand.

### Means for Solving the Problem

According to the invention, a foldable portable terminal apparatus comprises: a first casing including an operation portion, and a second casing including a display portion, which are connected through a connection portion, wherein the connection portion comprises: a first rotation shaft which allows the second casing to rotate with respect to the first casing in a first direction; and a second rotation shaft which allows the second casing to rotate with respect to the first casing in a second direction perpendicular to the first direction, wherein the first rotation shaft comprises a protrusion portion, wherein the first casing comprises a slide sheet, a cam follower member, a first elastic member configured to urge the cam follower member and a second elastic member configured to connect the slide sheet and the cam follower member, and wherein when the first rotation shaft rotates, the protrusion portion presses the cam follower member, and the slide sheet connected to the cam follower member through the second elastic member moves.

By this configuration, movement of the slide sheet can be interlocked with a rotation of the second casing. Also, a drive mechanism is not broken even in the case of opening or closing the second casing in a state in which a key remains fixed by an external force.

In the portable terminal apparatus of the invention, the cam follower member and the second elastic member are formed integrally. This configuration can implement, with a simple configuration, the portable terminal apparatus without breaking the drive mechanism even in the case of opening or closing the second casing in the state in which the key remains fixed by the external force. Further, in the portable terminal apparatus of the invention, the first casing further comprises: a key top sheet; and a frame portion which surrounds the slide sheet, and the key top sheet is fastened to the frame portion. By this configuration, the operation portion has a hermetically closed structure by the key top sheet and the frame portion, and a dustproof or waterproof function can be enhanced.

Further, in the portable terminal apparatus of the invention, the first casing comprises the first elastic member configured to press the cam follower member connected to the slide sheet toward a connection portion side (a side in which the first rotation shaft is disposed) in a longer direction of the first casing, and stopper means for abutting on the slide sheet in a direction in which the first elastic member presses.

By this configuration, in a state of opening the second casing, the cam follower member is pressed to the connection portion side by the first elastic member, and the slide sheet connected to the cam follower member abuts on the stopper and stops, so that position accuracy with respect to a transparent display window can be improved by urging the slide sheet to the connection portion side always.

In a state of closing the second casing, the cam follower member is pressed to a side opposite to the connection portion by the protrusion portion of the first rotation shaft, and the slide sheet is pressed through the second elastic body on the cam follower member. At this time, the slide sheet stops by the stopper disposed in the first casing and is urged to the side opposite to the connection portion by the second elastic member, so that the position accuracy with respect to the transparent display window can be improved.

In the portable terminal apparatus of the invention, on the slide sheet, a first character group is printed in the first direction and a second character group is printed in the second direction perpendicular to the first direction, the operation portion comprises the key top sheet on a print surface side of the slide sheet, the key top sheet comprises a transparent display window configured to allow one of the first character group and the second character group to be visible from an outside when the slide sheet slides, and the first character group overlaps with the display window in a state of opening the second casing with respect to the first casing in the first direction, and the second character group overlaps with the display window in a state of opening the second casing with respect to the first casing in the second direction.

In the portable terminal apparatus of the invention, characters of the first character group and characters of the second character group are printed alternately. By this configuration, orientation of display and key arrangement of the operation portion can be switched correctly with respect to a display surface of the second casing when the second casing is rotated with respect to the first casing.

In the portable terminal apparatus of the invention, the protrusion portion urges the cam follower member and the slide sheet to the side opposite to the connection portion in the longer direction of the first casing.

By this configuration, it is possible to prevent a breakage of the drive mechanism even in the case of opening or closing the second casing in the state in which the key remains fixed by the external force.

The portable terminal apparatus of the invention further comprises radio communication means and television broadcast receiving means, wherein a character for radio communication and a character for television receiving are written on the slide sheet, wherein the character for radio communication is displayed when the connection portion and the second casing are opened in the longer direction with respect to the first casing, and wherein the character for television receiving is selectively displayed when the second casing are opened in a shorter direction with respect to the first casing.

By this configuration, the character of radio communication can correctly be displayed when a radio communication function is used, and the character for television receiving can be displayed when a television receiving function is used.

### ADVANTAGES OF THE INVENTION

According to the invention, in a foldable portable terminal apparatus, e.g., a mobile telephone, a game machine or PDA (Personal Digital Assistants) having a television receiving function, including a connection portion containing two rotation shafts so as to open and close the apparatus in a first direction and a second direction, the characters printed on the operation portion such as the ten-key pad can be changed according to the orientation of the display device of liquid crystal etc. by when a second casing is opened from a folded state by rotating the rotation shaft of the connection portion.

Since switching is performed mechanically, the characters printed on the operation portion such as the ten-key pad can be switched according to the orientation of the display device of liquid crystal etc. included in the second casing by rotating a display surface of the second casing in the first direction or the second direction with respect to the first casing when a power supply of the portable terminal apparatus is not turned on.

The operation portion is fastened to the key top sheet, the frame portion and the pusher sheet, which can suppress the dust etc. to enter on the slide on which the characters are printed, thereby providing a superior dustproof or waterproof function.

According to the invention, in addition to the configuration described above, the radio communication means and the television broadcast receiving means are further provided, and the character for radio communication and the character for television receiving are written on the slide sheet, and the character for radio communication is displayed when the connection portion and the second casing are opened in the first direction with respect to the first casing, and the character for television receiving is selectively displayed when the second casing are opened in the second direction with respect to the first casing.

By this configuration, the character for radio communication can be displayed in the case of being opened in the first direction, and the character for television receiving can be displayed in the case of being opened in the second direction.

Further, by providing the first elastic member configured to urge the cam follower member and the second elastic member configured to connect the slide sheet and the cam follower member, it is possible to implement the portable terminal apparatus which includes the configuration of changing the characters according to the orientation of the display device and in which the breakage of the drive mechanism is prevented even in the case of opening or closing the second casing in the state in which the key remains fixed by the external force, for example, the state in which the key is held by hand.

### BRIEF DESCRIPTION OF THE DRAWINGS

FIG. 1 is a perspective view showing a state in which a casing of a mobile telephone according to a first embodiment of the invention is opened in a first direction.

FIG. 2 is a perspective view showing a state in which the casing of the mobile telephone according to the first embodiment of the invention is opened in a second direction.

FIG. 3 is an exploded perspective view of a main part of an operation portion of the mobile telephone according to the first embodiment of the invention.

FIG. 4 is a perspective view showing a structure of a portion related to a slide sheet of the first embodiment of the invention.

FIG. 5 is a partially sectional view showing the structure of a poration related to the slide sheet of the first embodiment of the invention.

FIG. 6(a) is a partially sectional view showing the state in which the casing of the mobile telephone according to the first embodiment of the invention is opened in the first direction, and FIG. 6(b) is a partially sectional view showing the state in which the casing of the mobile telephone according to the first embodiment of the invention is opened in the first direction.

FIG. 7 is a plan view showing the state in which the casing of the mobile telephone according to the first embodiment of the invention is opened in the first direction.

FIG. 8 is a partially sectional view at the time of closing the mobile telephone according to the first embodiment of the invention.

FIG. 9(a) is a partially sectional view showing the state in which the casing of the mobile telephone according to the first embodiment of the invention is opened in the second direction, and FIG. 9(b) is a plan view showing the state in which the casing of the mobile telephone according to the first embodiment of the invention is opened in the second direction.

FIG. 10 is a sectional view showing details of a slide mechanism of the state in which the casing of the mobile telephone according to the first embodiment of the invention is opened in the first direction.

FIG. 11 is a sectional view showing a detail of movement of the slide sheet associated with an action of closing the casing of the mobile telephone according to the first embodiment of the invention in the first direction.

FIG. 12 is a sectional view showing a protection function of the case of closing the second casing 2 in the first direction in a state in which a key remains unmoved in the first embodiment of the invention.

FIG. 13 is a sectional view showing a protection function of the case of opening the second casing in the first direction from a state of closing the second casing 2 in the state in which the key remains unmoved in the first embodiment of the invention.

FIG. 14 is a sectional view showing a configuration in which a stopper for positioning the slide sheet is separately provided from the first casing 1 in the first embodiment of the invention.

FIG. 15 is a sectional view of the case of being constructed so that a protrusion portion pushes a cam follower member 7 at the time of opening the second casing in the first embodiment of the invention.

FIG. 16 is a perspective view showing a structure of the portion related to the slide sheet of a second embodiment of the invention.

FIG. 17 is a partially sectional view showing the structure of the portion related to the slide sheet of the second embodiment of the invention.

FIG. 18 is a perspective view showing a state in which a second casing of a conventional mobile telephone is opened in a first direction.

FIG. 19 is a perspective view showing a state in which the second casing of the conventional mobile telephone is opened in a second direction.

FIG. 20 is a plan view of a conventional electronic device.

FIG. 21 is a partially sectional view of the conventional electronic device.

### DESCRIPTION OF REFERENCE SIGNS

1 FIRST CASING
2 SECOND CASING
3 CONNECTION PORTION
4 CIRCUIT BOARD
5 DIAPHRAGM
6 FRAME PORTION
7 CAM FOLLOWER MEMBER
8 SPRING HOLDING PORTION
9 FIRST ROTATION SHAFT
10 SECOND ROTATION SHAFT
11 FIRST COMPRESSION SPRING (FIRST ELASTIC MEMBER)
12 PROTRUSION PORTION
13 SLIDE SHEET
16 KEY TOP SHEET
17 SECOND COMPRESSION SPRING (SECOND ELASTIC MEMBER)
18 SLIDE SHEET MOUNTING PLATE
19 PUSHER SHEET
20 STOPPER
22 FIRST TORSION COIL SPRING
23 SECOND TORSION COIL SPRING
51 OPERATION PORTION

### BEST MODE FOR CARRYING OUT THE INVENTION

### First Embodiment

In a first embodiment of the invention, the problems is solved by using a state of a connection portion serving as a third casing and configured to connect a first casing and a second casing, in which the connection portion is opened or remains closed with respect to the first casing including an operation portion depending on whether the second casing is opened with respect to the first casing in a first direction (first direction of the casing) or a second direction (second direction of the casing).

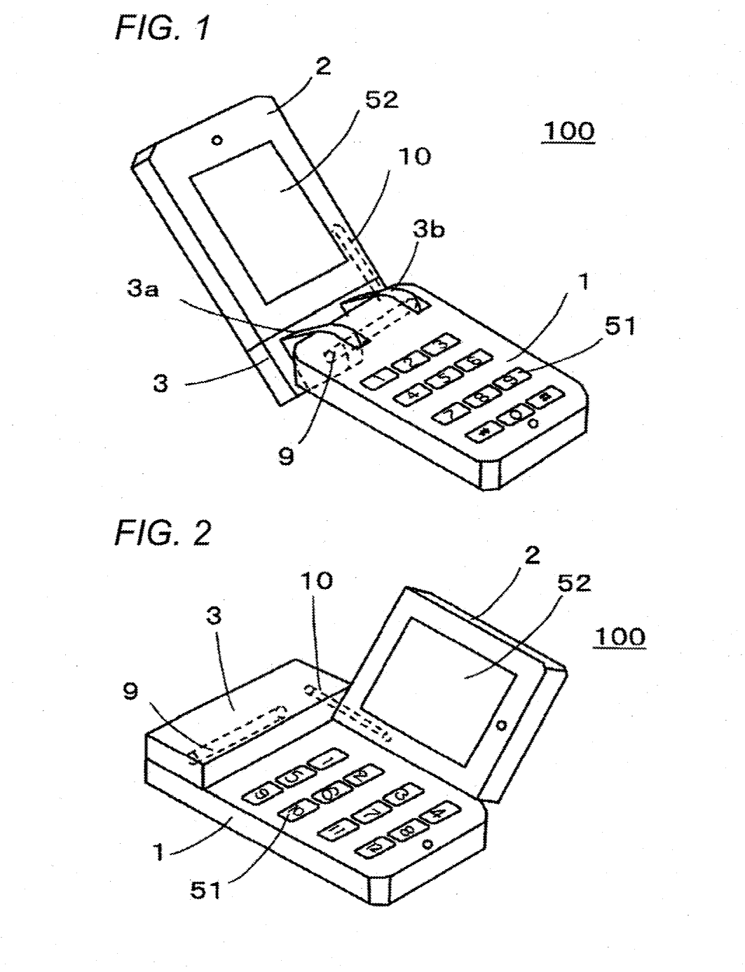

FIG. 1 is a perspective view showing a state in which a second casing 2 of a foldable mobile telephone 100 according to the first embodiment of the invention is opened in a first direction. A first casing 1 including an operation portion 51 rotatably supports a first rotation shaft 9 by bearings (not shown). In a connection portion 3, the first rotation shaft 9 is fixed integrally to the connection portion 3 by shaft holding portions 3a, 3b.

A protrusion portion 12 which is not shown but described later is fixed to the first rotation shaft 9. As a result, the connection portion 3, the first rotation shaft 9 and the protrusion portion 12 rotate as an integral component. In one corner of the connection portion 3, a second rotation shaft 10 shown by a broken line is provided so as to extend perpendicular to the first rotation shaft 9, and the second casing 2 is rotatably mounted to the second rotation shaft 10. A display portion 52 is provided in the second casing 2.

In the foldable mobile telephone 100, when the second casing 2 is opened in the first direction with respect to the first casing 1, ten-key numeric characters of the operation portion 51 are displayed by ten-key arrangement for telephone defined by standards and are oriented in the first direction as a vertical direction thereof, so as to be used as the telephone.

FIG. 2 is a perspective view showing a state in which the second casing 2 of the foldable mobile telephone 100 according to the first embodiment of the invention is opened in a second direction. Arrangement of each portion is the same as that of FIG. 1, but the second casing 2 rotates around the second rotation shaft 10 from a closed state, and the second casing 2 is opened in the second direction with respect to the first casing 1. In addition, the connection portion 3 is closed with respect to the first casing 1.

At this time, as for the ten-key numeric characters of the operation portion 51, the characters “1”, “2”, “3” and “4” are arranged from the left in the first row so as to allow an easy usage as a television receiver. The characters “5”, “6”, “7” and “8” are arranged from the left in the second row. The characters “9”, “10”, “11” and “12” are arranged in the third row. A direction of the numeric characters is also displayed in the second direction of the casing as a vertical direction thereof.

In the foldable mobile telephone 100, printed characters of the operation portion 51 can be seen from the outside in orientation thereof suitable for orientation of display of the liquid crystal display portion by movement of a slide sheet described later in each of cases in which the second casing 2 is opened with respect to the first casing 1 in the first direction and in which the second casing 2 is opened with respect to the first casing 1 in the second direction. The configuration will hereinafter be described in detail.

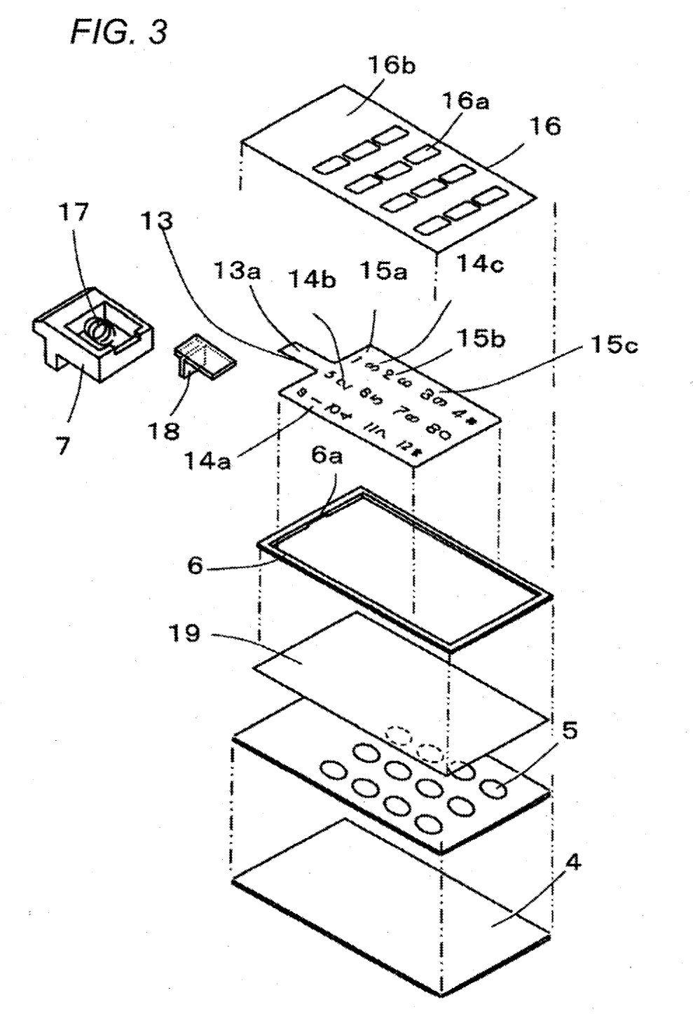

FIG. 3 is an exploded perspective view of a main part of the operation portion 51. As shown in FIG. 3, the contents of keys such as numeric characters are printed on a surface of a slide sheet 13. Numeric characters for ten-key pad (for example, 14a, 14b, 14c) of “1” to “10” are printed and arranged.

Also, numeric characters for television channel (for example, 15a, 15b, 15c) are printed and arranged alternately with the numeric characters for ten-key pad. Orientation of the numeric characters (a first print group) for ten-key pad is set in orientation in the first direction of the second casing 2 as the vertical direction thereof, and the numeric characters (a second print group) for television channel are printed by changing an angle by 90° so as to be oriented in the second direction.

The slide sheet 13 is made of a plastic sheet which is thin but has rigidity enough to prevent buckling. As shown in FIG. 3, a follower mounting portion 13a is formed in a protrusion shape in one end.

A frame portion 6 is provided in the periphery of the slide sheet 13 of FIG. 3, and a pusher sheet 19 is provided on a back surface side of the slide sheet 13 (a surface opposite to a print surface). The frame portion 6 is disposed so as to surround the periphery of the slide sheet in order to regulate movement of the slide sheet 13.

A step portion 6a is provided in a lower surface of the frame portion 6 which thins a thickness of the frame portion 6 such that the follower mounting portion 13a of the slide sheet 13 can pass through the step portion 6a. The pusher sheet 19 is adhered and fixed to the lower surface of the frame portion 6 in order to improve the click feel of the key.

The step 6a is not always necessarily provided, and thinning may be achieved by forming a portion 6a in a form of opening such that a part of the frame portion 6 has opened portion.

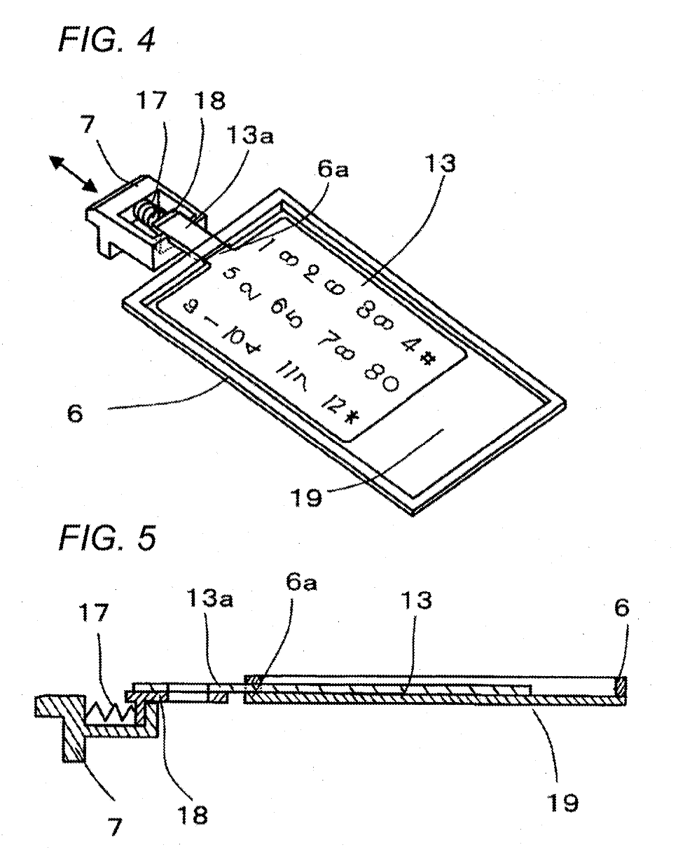

A slide sheet mounting plate 18 is fixed to the follower mounting portion 13a by: placing slide sheet 13 on the pusher sheet 19 in a state of adhering and fixing the pusher sheet 19 to the lower surface of the frame portion 6; and inserting the follower mounting portion 13a formed in one end of the slide sheet 13 into a gap between the pusher sheet 19 and the step portion 6a of the frame portion. FIG. 4 shows a perspective view showing this state and FIG. 5 is a sectional view showing this state.

Returning to FIG. 3, a key top sheet 16 made of a plastic member etc. is laminated to a front surface of the slide sheet 13. In the key top sheet 16, display windows 16a are defined, and a remaining portion 16b is defined to be opaque. In order to allow only the first print group or the second print group of the slide sheet to be visible, the display windows 16 are arranged so as to adapt to printing distances and sizes of characters of one of the print groups.

The key top sheet 16 is adhered and fixed to an upper surface of the frame portion 6. The slide sheet 13 slides in a space hermetically closed by the key top sheet 16, the frame portion 6 and the pusher sheet 19.

As described later, a cam follower member 7 moves so as to follow the protrusion portion 12 mounted in the first rotation shaft 9 not shown in FIG. 3 when the first rotation shaft 9 reaches a predetermined angle or more. Therefore, the slide sheet 13 connected to the cam follower member 7 through a second compression spring 17 (a second elastic member) slides in the space formed by the frame portion 6, the pusher sheet 19 and the key top sheet 16, while following a rotation of the first rotation shaft 9.

In FIG. 3, diaphragms 5 and a key circuit board 4 are provided below the frame portion 6 and the pusher sheet 19. The number of diaphragms 5 are smaller than the number of characters and numeric characters printed on the slide sheet 13.

When the diaphragm 5 is pushed from above, a center portion of the diaphragm 5 is dented, and a contact point provided in a position superimposed on the center portion contacts and electrically connected with a contact circuit for key on the key circuit board 4, whereby the push is detected.

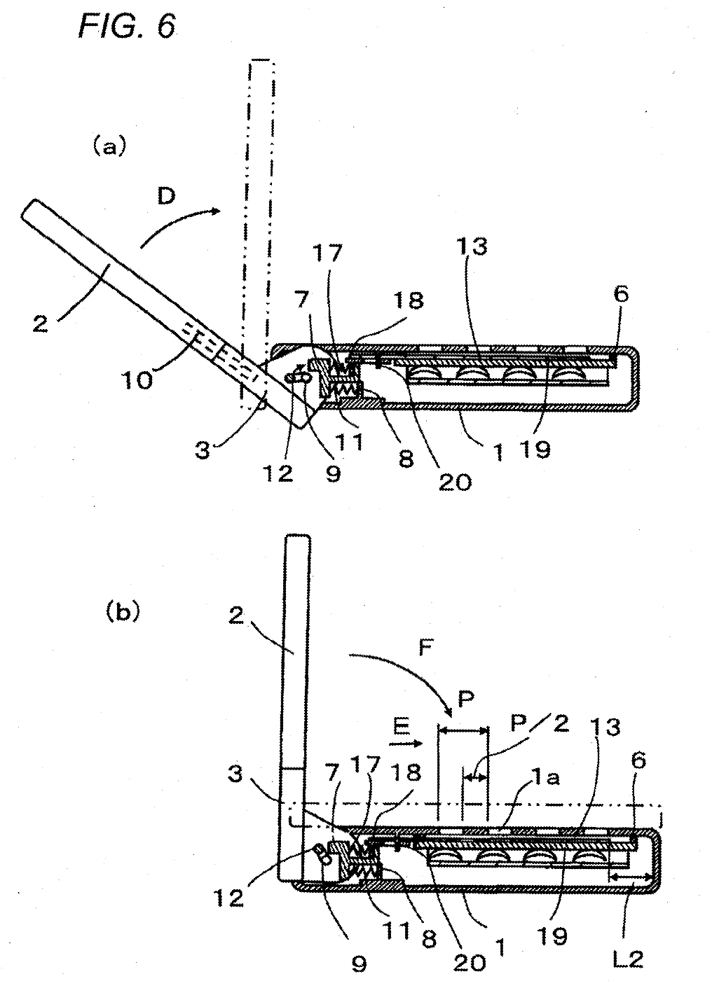

FIG. 6(a) shows a state in which the second casing 2 of the foldable mobile telephone 100 according to the first embodiment of the invention is closed toward a direction of D from a state of being opened in the first direction to a position of 90° as in a partially sectional view.

A spring holding portion 8 is provided in the first casing 1 and supports a first compression spring 11 (a first elastic member). Accordingly, an end face of the cam follower member 7 connected to the slide sheet 13 through the second compression spring 17 can be pushed by the protrusion portion 12 fixed to the first rotation shaft 9.

The slide sheet 13 is urged to move in a left direction of the drawing by a force of the first compression spring 11. A stopper configured to stop movement of the left direction of the drawing of the cam follower member 7 may be provided so as to protrude from a part of the first casing.

Consequently, the slide sheet 13 stops in a position determined by the stopper, whereby it is possible to improve positioning accuracy between the display windows 16a formed in the key top sheet 16 and the slide sheet 13 connected to the cam follower member 7 through the second compression spring 17.

The protrusion portion 12 is provide so as to revolve in association with rotation of the first rotation shaft 9. When the protrusion portion 12 abuts on a top of the cam follower member 7 connected to the slide sheet 13, and then the first rotation shaft 9 rotates, the protrusion portion 12 causes the slide sheet 13 to slide and move.

In the state of FIG. 6(a), the cam follower member 7 does not contact the protrusion portion 12. However, by rotating the second casing 2 in the first direction to close the second casing 2, the cam follower member 7 contacts the protrusion portion 12.

Since the cam follower member 7 does not contact the protrusion portion 12 up to here, the slide sheet does not move, whereby it is possible to maintain a state of a normal character indication suitable for browsing of electronic mail or a telephone call as the mobile telephone.

FIG. 6(b) shows a state of moving the second casing 2 in the first direction from a predetermined angle to a direction to close. The first casing 1 is shown by a cross section.

The connection portion 3, as long as the second casing 2, moves with respect to the first casing 1 in the first direction for closing as shown by arrow F. When the connection portion 3 is being closed, the first rotation shaft 9 fixed integrally to the connection portion 3 also rotates in the direction of the arrow F. When the first rotation shaft 9 rotates, the protrusion portion 12 also starts to revolve in association therewith. When the protrusion portion 12 revolves in the direction of the arrow F, the cam follower member 7 is moved in a right direction of the drawing, that is, a direction of arrow E.

Accordingly, although the slide sheet provided in the first casing moves by performing an action of closing the second casing, the user can switch the characters without being aware of the switch since the characters are hidden by the second casing.

The amount of movement of the cam follower member 7 is set at a half of one pitch of adjacent windows 1a of the first casing 1. That is, when one pitch is defined as “P”, the cam follower member 7 moves to the right by “P/2” and the slide sheet 13 to which the cam follower member 7 is fixed also moves to the right by “P/2”.

In the foldable mobile telephone 100 of the invention, the cam follower member 7 starts to move by the protrusion portion 12 when the second casing 2 is closed in the first direction to a predetermined angle. As a result, until the second casing 2 is closed in the first direction by 90°, orientation of display and key arrangement of the operation portion 51 do not change. Thereafter, when the second casing 2 starts to be closed in the first direction, the switching of the characters starts. When the second casing 2 is completely closed, the switching of characters is completed.

The first embodiment provides the example of starting the switching of orientation of display and key arrangement when the second casing 2 is closed in the first direction to 90° or less, but the angle is not limited to 90°.

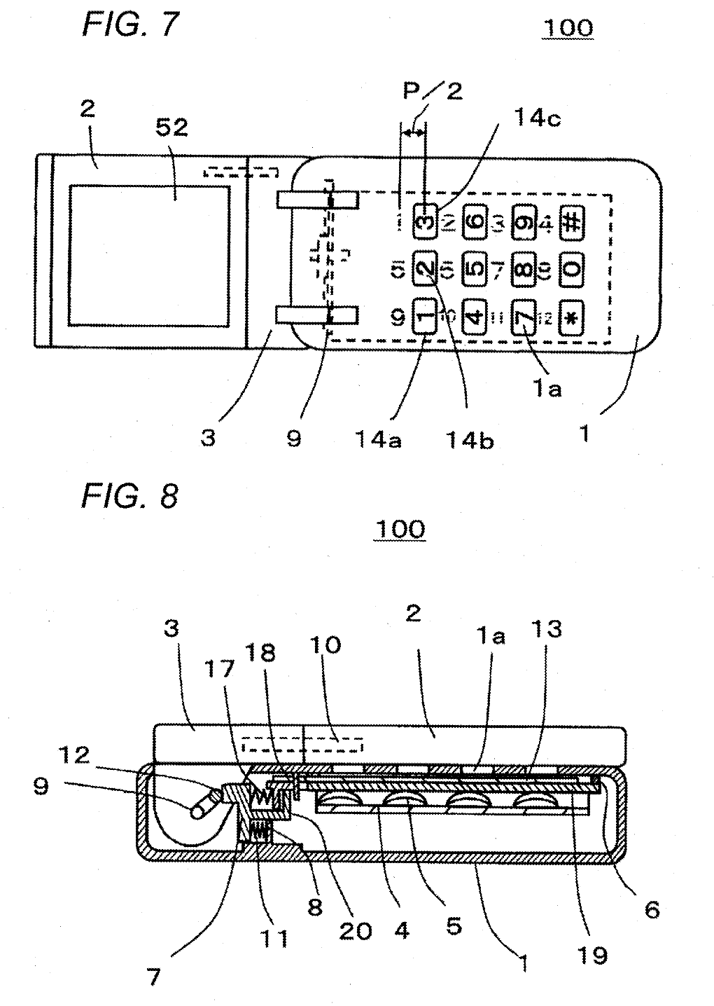

FIG. 7 shows a plan view of the foldable mobile telephone 100 at the time when the second casing 2 is fully opened in the first direction. Since the second casing 2 is opened together with the connection portion 3, numeric characters of operation buttons are visible through the transparent windows 1a of the first casing 1.

In FIG. 7, the characters “1”, “2” and “3” are seen and arranged in the first column from the top of orientation of characters for the telephone. The characters “4”, “5” and “6” are arranged in the second column. Then, “7”, “8” and “9” are arranged in the third column. The characters “*”, “0” and “#” are arranged in the fourth column. Accordingly, when the display portion 52 of the foldable mobile telephone 100 is set in a portrait state, the user can push the ten-key buttons as numeric arrangement of the telephone without any difficulty to select the buttons.

FIG. 8 shows a state in which the second casing 2 and the connection portion 3 are closed with respect to the first casing 1, and shows the inside of the first casing 1 by a cross section. The circuit board 4 fixed by a support portion (not shown) is present inside the first casing 1, and the diaphragms 5 are arranged on the circuit board 4 such that the number thereof is smaller than the number of characters and numeric characters printed on the slide sheet 13.

The pusher sheet 19 is fixed on the diaphragms 5. In the drawing, sectional shapes of the frame portion 6 and the pusher sheet 19 are emphasized so as to be clearly shown. However, the actual overall thickness is thin, and when the pusher sheet 19 is pushed from above, the pusher sheet 19 bends, and the center of the diaphragm 5 just under the push is dented.

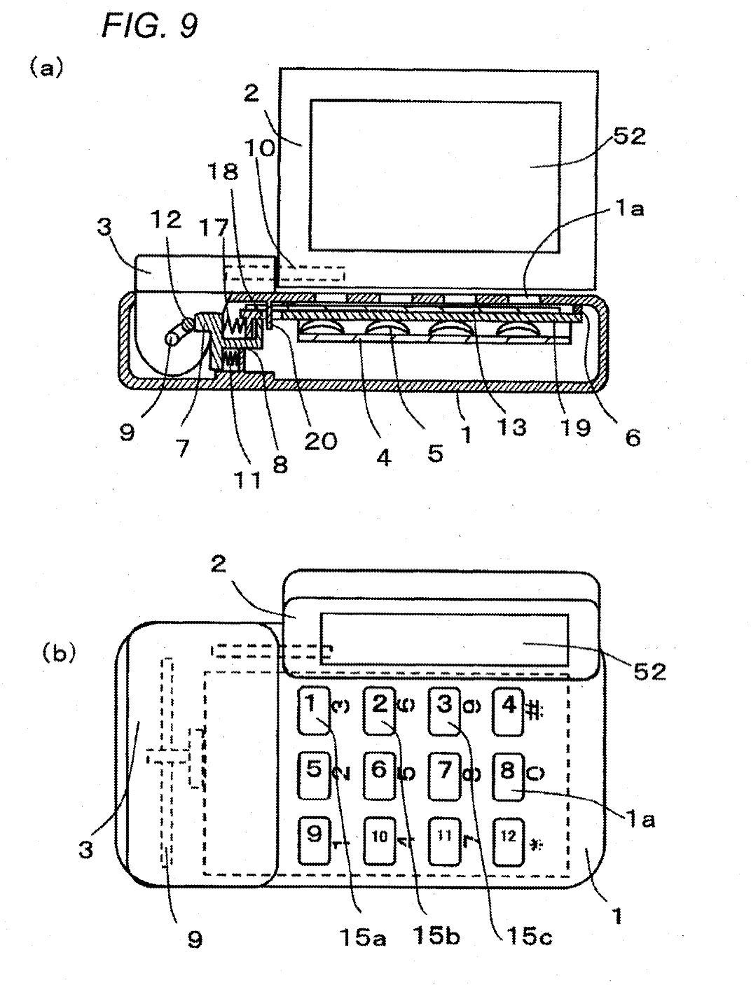

FIG. 9(a) shows a state in which the second casing 2 is opened in the second direction. The first casing 1 is shown by a cross section. The connection portion 3 remains closed with respect to the first casing 1, but the second casing 2 rotates around the second rotation shaft 10 such that the display portion 52 are seen.

Since the connection portion 3 remains closed with respect to the first casing 1, the first rotation shaft 9 does not rotate. That is, the protrusion portion 12 does not revolve, and a position of the slide sheet 13 is the same as that when the second casing 2 of FIG. 6 is closed.

FIG. 9(b) shows a plan view of the foldable mobile telephone 100 when the second casing 2 is opened in the second direction. Since the second casing 2 is opened, numeric characters of operation buttons are visible through the display windows 1a of the first casing 1.

In FIG. 9(b), the numeric characters “1”, “2”, “3” and “4” of the numeric characters of “1” to “12” for television channel are seen and arranged in the first column from the top of orientation of characters. The characters“5”, “6”, “7” and “8” are arranged in the second column. The characters “9”, “10”, “11” and “12” are arranged in the third column.

When the display portion 52 of the foldable mobile telephone 100 is set in a landscape state in order to view a television broadcast, the user can push any of the channels of “1” to “12” without any difficulty to select the buttons.

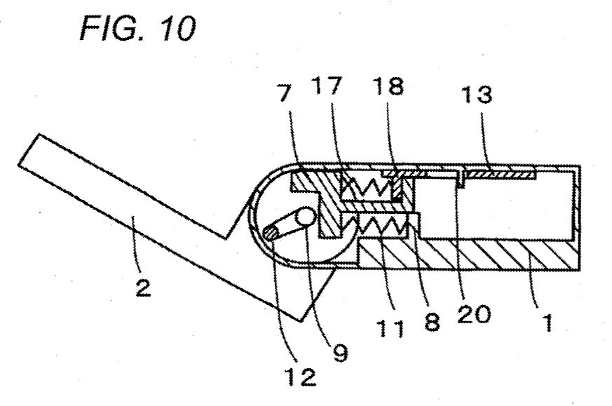

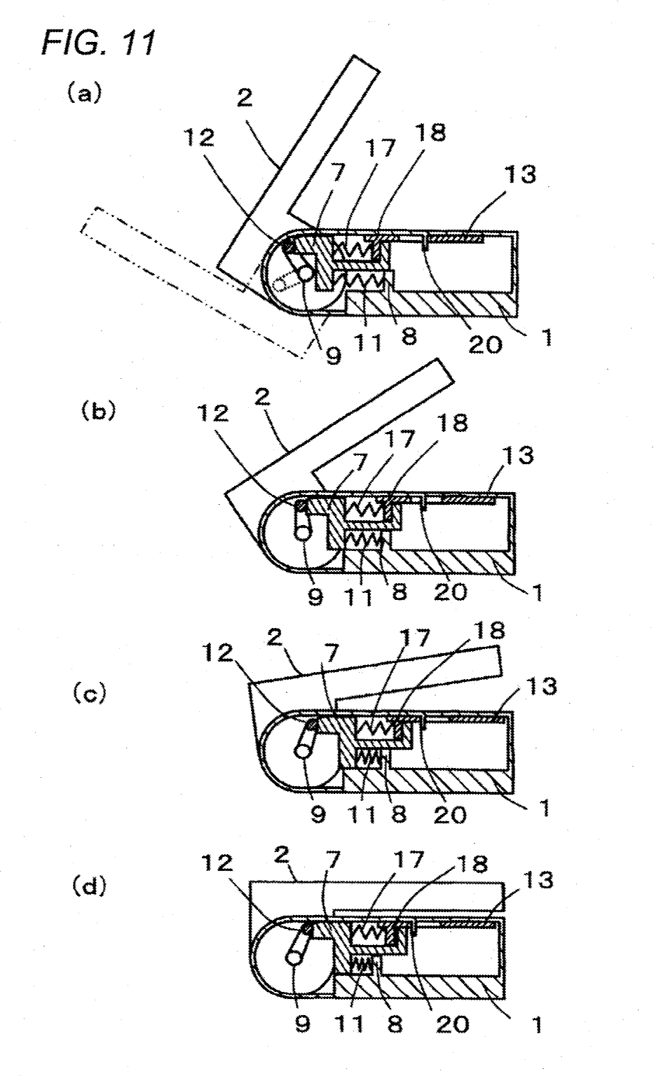

Next, movement of the slide sheet 13 and the protrusion portion 12 associated with opening and closing actions of the second casing 2 will be described in detail with reference to FIGS. 10 and 11.

In a state of FIG. 10 in which the second casing 2 is opened in the first direction, the cam follower member 7 is urged toward the left side of the drawing by an elastic force of the first compression spring 11 provided in the first casing 1. At this time, the slide sheet 13 abuts on the cam follower member 7 and the slide sheet mounting plate 18, so that the force of the first compression spring 11 is transmitted and the slide sheet 13 is urged to the left side of the drawing. Consequently, the slide sheet is pressed on a stopper 20 provided in the first casing 1.

By this configuration, a position of the slide sheet does not fluctuate, and position accuracy with respect to the transparent display window can be improved. Next, even when the second casing 2 is closed in the first direction from the state of FIG. 10, the cam follower member 7 is not pushed by the protrusion portion 12 until a state of FIG. 11(a) in which the protrusion portion 12 contacts the cam follower member 7, so that the slide sheet 13 connected to the cam follower member 7 through the second compression spring 17 does not move.

When the second casing 2 is further closed in the first direction from the state of FIG. 11(a), the protrusion portion 12 pushes the cam follower member 7, whereby the cam follower member 7 is pushed by the protrusion portion 12 and moves in the right direction. Here, an elastic force of the second compression spring 17 is set larger than a force by which the slide sheet 13 moves, so that the slide sheet 13 moves in the right direction of the drawing (FIG. 11(b)).

When the second casing 2 is further closed in the first direction from the state of FIG. 11(b), the slide sheet 13 further moves in the right direction of the drawing and abuts on the stopper 20 provided in the first casing 1 and stops (FIG. 11(c)).

When the second casing 2 is further closed in the first direction from the state of FIG. 11(c), the cam follower member 7 is further pushed by the protrusion portion 12. Here, the elastic force of the second compression spring 17 is set smaller than a force by which the slide sheet 13 is fixed by the stopper 20. Therefore, the second compression spring 17 contracts and functions as a damper, whereby the slide sheet 13 does not move in a state of abutting on the stopper 20 (FIG. 11(d)).

Also, in the state of FIG. 11(d) in which the second casing 2 is closed in the first direction, the slide sheet 13 is urged in the right direction of the drawing by the elastic force of the second compression spring 17, so that position accuracy with respect to the display window can be improved.

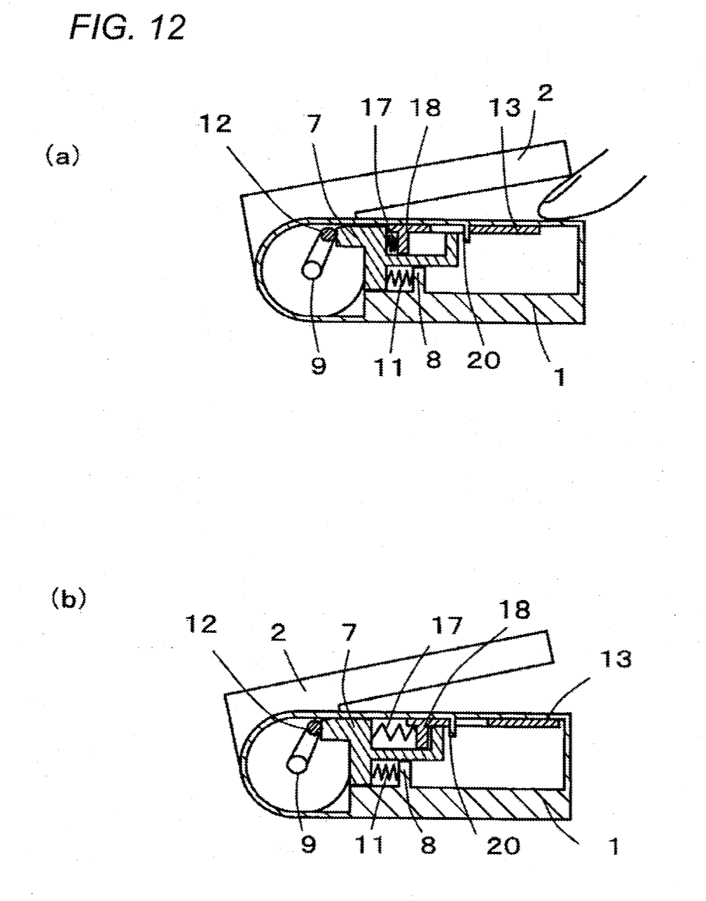

FIG. 12 shows a protection function in the case in which the second casing 2 is closed in the first direction in a state in which a key remains unmoved by an external force, for example, the second casing is closed in a state of being held by hand.

As shown in FIG. 12(a), even when the cam follower member 7 moves in the right direction of the drawing in a state in which the slide sheet 13 is fixed, a force by which the cam follower member 7 pushes the slide sheet 13 is absorbed by the second compression spring 17. Consequently, the second compression spring 17 serves as the damper, thereby preventing a breakage of a drive mechanism or deformation of the slide sheet 13.

In this case, when the external force is eliminated, the slide sheet 13 moves in the right direction of the drawing and returns to a regular position by the elastic force of the second compression spring 17 as shown in FIG. 12(b).

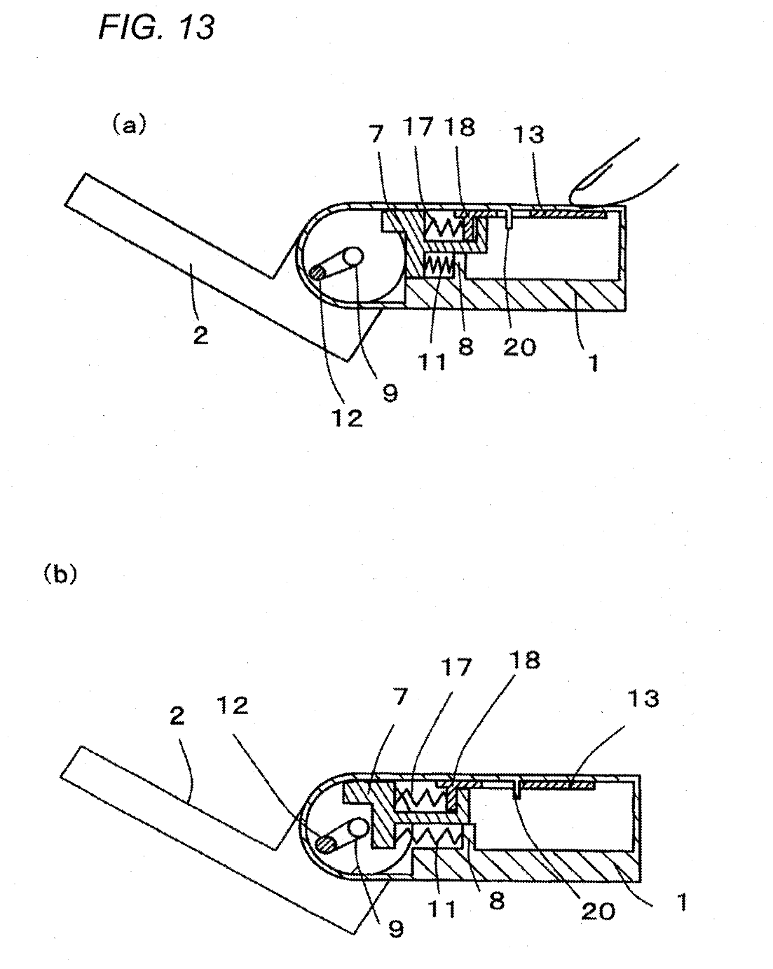

Next, FIG. 13 shows the protection function in the case in which the second casing 2 is opened in the first direction from a closed state of the second casing 2 in the state in which a key remains unmoved by an external force, for example, the second casing is closed in a state of being held by hand.

As shown in FIG. 13(a), in the case of being opened in a state of fixing the slide sheet 13, the protrusion portion 12 revolves in a direction opposite to a direction of pushing the cam follower member 7, so that the first rotation shaft 9 does not interlock with the slide sheet 13 and rotates independently, whereby the slide sheet 13 is not deformed or the drive mechanism is not broken.

When the external force is eliminated, the slide sheet 13 moves in the left direction of the drawing and returns to the regular position by the elastic force of the first compression spring 11 as shown in FIG. 13(b).

The first embodiment described above shows the example in which as the configuration of transmitting movement of the protrusion portion 12, the cam follower member 7 and the compression spring are separately provided. However, an integrally-formed elastic body of a sponge, an air cushion, a rubber member or a molded product having a resinous bellows elastic function may be used.

By the integral formation, it is possible to implement, by a simple configuration, a portable terminal apparatus without breaking the drive mechanism even in the case of opening or closing the second casing in the state in which a key remains fixed by an external force.

Further, the first embodiment shows that the protrusion portion 12 is fixed to the first rotation shaft 9, but other structures may be used as long as rotation of the first rotation shaft 9 interlocks with and transmits to the protrusion portion 12. For example, the first rotation shaft 9 may interlock with the protrusion portion 12 by disposing another shaft between a shaft of the protrusion portion 12 and the first rotation shaft 9. Consequently, a position of the shaft of the protrusion portion can be set arbitrarily.

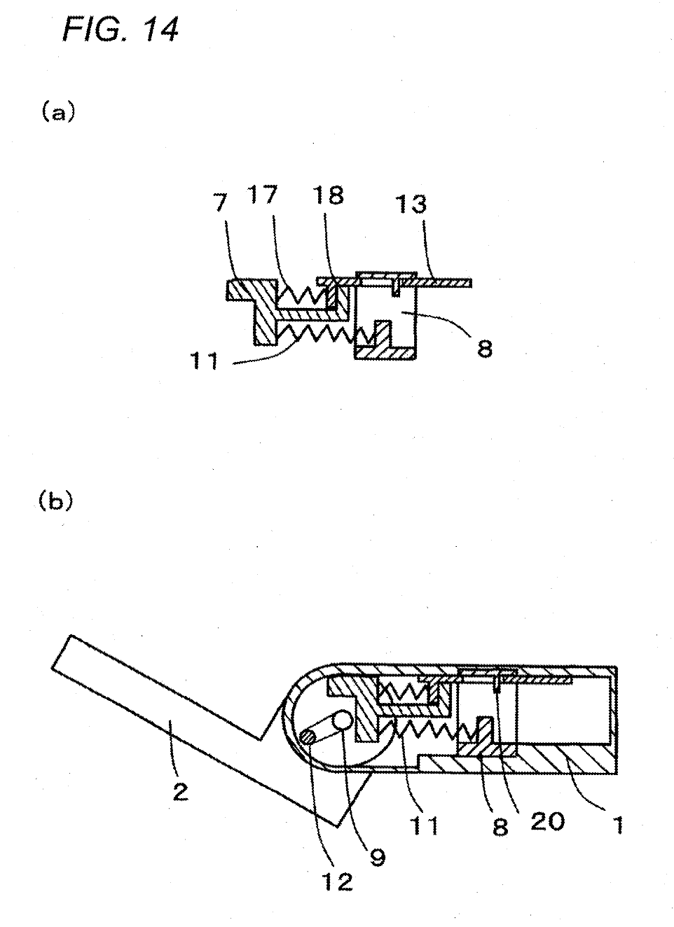

The first embodiment shows that the stopper 20 for positioning the slide sheet is formed in the first casing 1. However, as shown in FIG. 14(a), a stopper may be provided separately from the first casing 1, and for example, as shown in FIG. 14(b), the stopper may be formed inside the frame portion 6 so as to position the slide sheet.

The first embodiment shows that the protrusion portion 12 pushes the cam follower member 7 when the second casing 2 is closed with respect to the first casing 1. In contrast, the protrusion portion 12 may push the cam follower member 7 when the second casing 2 is opened.

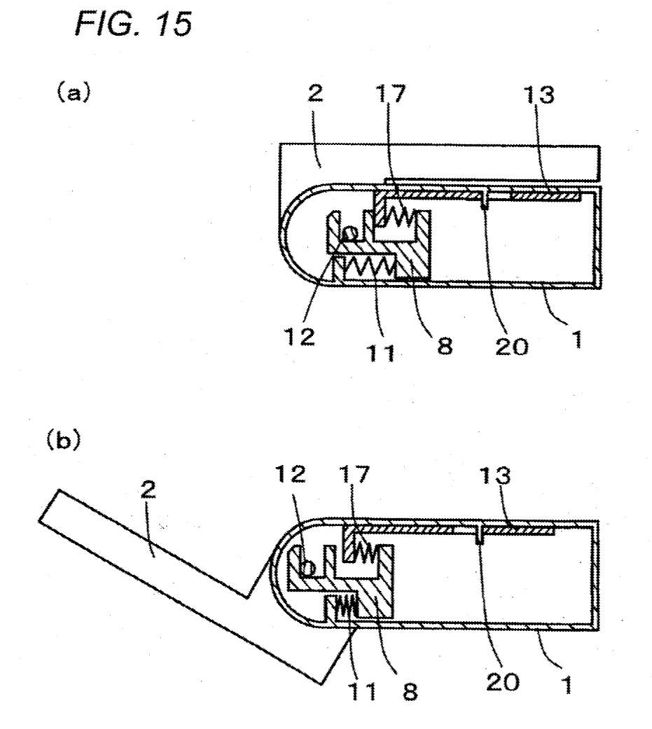

In this case, the first elastic member 11 urges the cam follower member 7 to the side opposite to the connection portion side in a longer direction when the second casing 2 is closed, whereby the slide sheet 13 moves to the side opposite to the connection portion side as shown in FIG. 15(a).

Also, when the second casing 2 is opened, the first elastic member 11 is pushed by the cam follower member 7 and is compressed to the connection portion side as shown in FIG. 15(b).

The movement by the rotation of the connection portion 3 serving as the third casing with respect to the first casing 1 is used as movement of the protrusion portion 12. Consequently, the slide sheet 13 connected to the cam follower member 7 is slid, whereby orientation of display and the contents of display of the operation portion are switched mechanically.

Therefore, even when a power supply of the portable terminal apparatus is not turned on, the orientation of display and the contents of display of the operation portion can be switched surely.

The first embodiment shows the mobile telephone having television receiving means as one type of the portable terminal apparatus, but the mobile telephone may have a game function and the key arrangement may be switched for game so as to be used as a game machine in the case of being opened in the second direction. In addition, characters displayed in two different directions may be arranged alternately.

As the arrangement of characters displayed in the case of opening the second casing in the second direction with respect to the first casing, the characters “1”, “2”, “3” and “4” are seen and arranged in the first column. The characters “5”, “6”, “7” and “8” are arranged in the second column.

The characters “9”, “10”, “11” and “12” are arranged in the third column. However, in order to do input of mail etc. without a feeling of strangeness, from the top of orientation of the characters, the characters “1”, “2” and “3” may be arranged in the first column, the characters “4”, “5” and “6” may be arranged in the second column and the characters “7”, “8” and “9” may be arranged in the third column.

### Second Embodiment

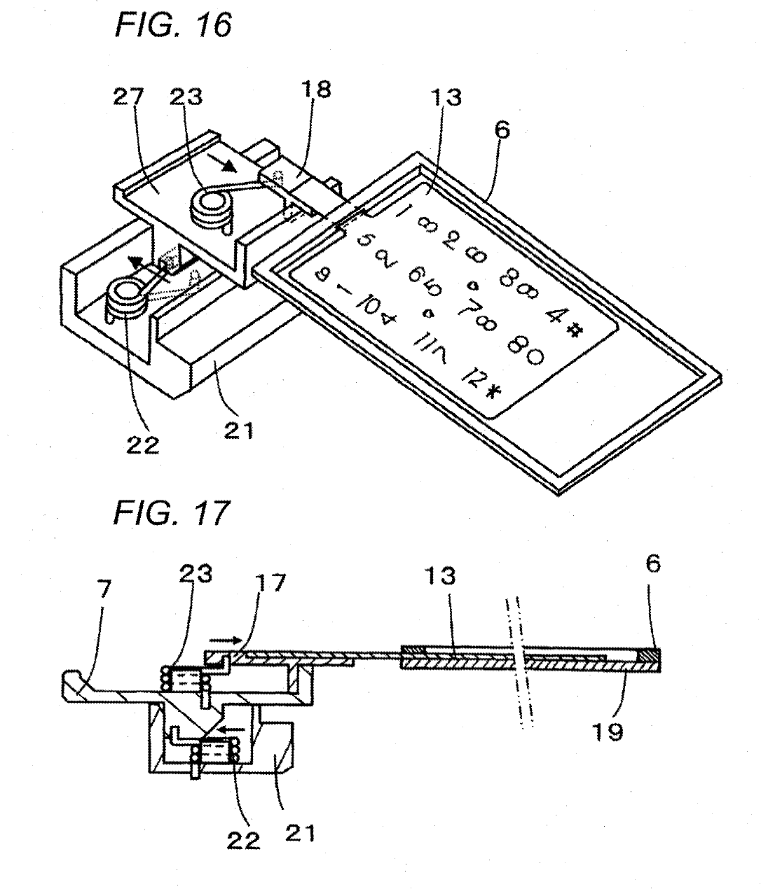

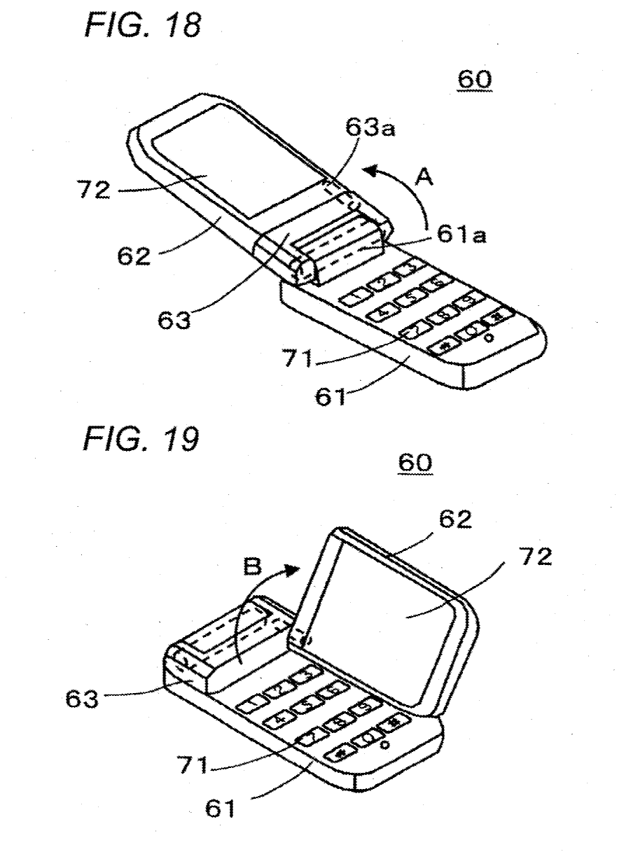

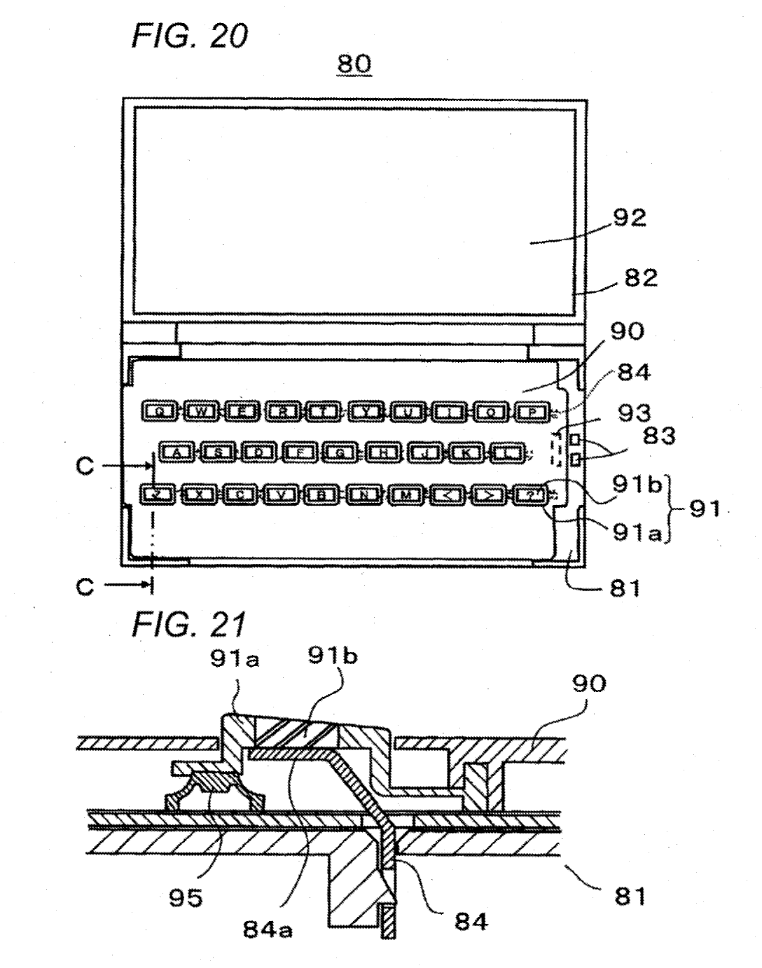

FIG. 16 shows a perspective view of a portion related to a slide sheet of a foldable mobile telephone according to a second embodiment of the invention. In FIG. 16, a holding portion 21 is provided in a first casing 1, a first torsion coil spring 22 is supported by the spring holding portion 21, and a cam follower member 27 is connected to a slide sheet 13 through a second torsion coil spring 23. An end face of the cam follower member 27 can be pushed by a protrusion portion 12 fixed to a first rotation shaft 9 (not shown).

FIG. 17 shows a sectional view of the portion related to the slide sheet of the foldable mobile telephone according to the second embodiment of the invention.

The second embodiment only differs from the first embodiment in that the torsion coil spring is used instead of the compression spring, as a kind of first and second springs. The other portion is similar to that of the first embodiment.

By changing the compression spring to the torsion coil spring, the cam follower portion can be thinned as compared with the case of using the compression spring. Therefore, the foldable mobile telephone can be thinned and miniaturized.

The invention has been described in detail with reference to the specific embodiments, but it is apparent to those skilled in the art that various changes or modifications can be made without departing from the spirit and scope of the invention.

The present application is based on Japanese patent application No. 2008-145314 filed on Jun. 3, 2008, and the contents of the patent application are hereby incorporated by reference.

### INDUSTRIAL APPLICABILITY

The invention is not limited to the foldable mobile telephone but may be applied to a foldable portable terminal apparatus including two rotation shafts for connections to allow open/close operations in a first direction and a second direction, such as a game machine used while switching a display screen in a portrait or landscape state, PDA having a television receiving function, etc.

1. A foldable portable terminal apparatus comprising:
a first casing including an operation portion, and a second casing including a display portion, which are connected through a connection portion,
wherein the connection portion comprises: a first rotation shaft which allows the second casing to rotate with respect to the first casing in a first direction; and a second rotation shaft which allows the second casing to rotate with respect to the first casing in a second direction perpendicular to the first direction,
wherein the first rotation shaft comprises a protrusion portion,
wherein the first casing comprises: a slide sheet; a cam follower member; a first elastic member configured to urge the cam follower member; and a second elastic member configured to connect the slide sheet and the cam follower member, and
wherein when the first rotation shaft rotates, the protrusion portion presses the cam follower member, and the slide sheet connected to the cam follower member through the second elastic member moves.

2. The foldable portable terminal apparatus according to claim 1, wherein the cam follower member and the second elastic member are formed integrally.

3. The foldable portable terminal apparatus according to claim 1,
wherein the first casing further comprises: a key top sheet; and a frame portion which surrounds the slide sheet, and
wherein the key top sheet is fastened to the frame portion.

4. The foldable portable terminal apparatus according to claim 1, wherein the first elastic member is configured to press the cam follower member toward a connection portion side in a longitudinal direction of the first casing.

5. The foldable portable terminal apparatus according to claim 1, comprising:
a stopper fixed on an inner side of the first casing,
wherein when the first elastic member presses the cam follower, the slide sheet abuts on the stopper in a movement direction thereof.

6. The foldable portable terminal apparatus according to claim 1,
wherein on the slide sheet, a first character group is printed in the first direction and a second character group is printed in the second direction perpendicular to the first direction,
wherein the first casing comprises the key top sheet provided on a print surface side of the slide sheet,
wherein the key top sheet comprises a transparent display window configured to allow one of the first character group and the second character group to be visible from an outside when the slide sheet slides, and
wherein the first character group overlaps with the display window in a state of opening the second casing with respect to the first casing in the first direction, and the second character group overlaps with the display window in a state of opening the second casing with respect to the first casing in the second direction.

7. The foldable portable terminal apparatus according to claim 6, wherein characters of the first character group and characters of the second character group are printed alternately.

8. The foldable portable terminal apparatus according to claim 6 or 7, further comprising radio communication means and television broadcast receiving means,
wherein a character for radio communication and a character for television receiving are written on the slide sheet,
wherein the character for radio communication is displayed when the connection portion and the second casing are opened in the longer direction with respect to the first casing, and
wherein the character for television receiving is selectively displayed when the second casing are opened in a shorter direction with respect to the first casing.

9. A foldable portable terminal apparatus comprising:
a first casing including an operation portion;
a second casing including a display portion;
a first rotation shaft which allows the second casing to rotate with respect to the first casing in a first direction;
a second rotation shaft which allows the second casing to rotate with respect to the first casing in a second direction perpendicular to the first direction,
a protrusion portion provided on the first rotation shaft and configured to revolve in association with a rotation of the first rotation shaft;
a slide sheet which is provided in the first casing and on which a first printing oriented in the first direction as a vertical direction thereof and a second printing oriented in the first direction as a vertical direction thereof are printed;
a cam follower member configured to move so as to follow the protrusion portion;
a first elastic member configured to urge the cam follower member; and
a second elastic member configured to connect the slide sheet and the cam follower member.
